(19) United States
(12) Patent Application Publication
(10) Pub. No.: US 2005/0050090 A1
(43) Pub. Date: Mar. 3, 2005

(54) Call method, copyright protection system and call system

(76) Inventors: Satoshi Kawahata, Kanagawa (JP); Yoshiyuki Kunito, Kanagawa (JP); Akihiro Hokimoto, Saitama (JP); Tadayuki Hattori, Tokyo (JP)

Correspondence Address: William S. Frommer, Esq.;FROMMER LAWRENCE & HAUG LLP, 745 Fifth Avenue, New York, NY, 10151, US

(21) Appl. No.: 10/897,917

(22) Filed: Jul. 23, 2004

(30) Foreign Application Priority Data
Jul. 25, 2003 (JP) 2003-280432

(51) Int. Cl. G06F 17/00

(52) U.S. Cl. 707/103 Y

(57) ABSTRACT

The copyright or the use right is sometimes prescribed in a sound source data file used as BGM, so that, in a sound source data file, acquired by a user, copying and re-distribution need to be suppressed without detracting from its serviceability. To this end, a VoIP client writes a downloaded sound source data file in a prescribed folder in a HDD forming an external storage device. When the writing is finished regularly, a hash value in the folder is calculated. The so calculated hash value is set in the user-oriented system information in the external storage device. When the VoIP client is booted for VoIP call, a hash value in a prescribed folder in the external storage device is calculated, and the so calculated hash value is compared to the hash value stored as the system information. If the result of comparison indicates that the hash value calculated is equal to the hash value stored, the sound source data file, stored in the prescribed area in the external storage device, is displayed on the GUI.

### BACKGROUND OF THE INVENTION

1. Field of the Invention

This invention relates to a call apparatus and a call method employing a network enabling the call under a high sound quality environment, such as the Internet. More particularly, it relates to a call apparatus, a copyright protection method for a file of the BGM or the SE, and a call system, in which not only the call voice but also the background music (BFM) or the effect sound (SE) may be transmitted/received.

This application claims priority of Japanese Patent Application No.2003-280432, filed in Japan on Jul. 25, 2003, the entirety of which is incorporated by reference herein.

2. Description of Related Art

In the Japanese Laid-Open Patent Publication 2001-118332, the present Assignee has disclosed a data distributing system for distributing optional data, such as data pertinent to a workpiece, such as a music workpiece or an image workpiece, to both the serial generation and the parallel generation, under optimum copying control.

In the Japanese Laid-Open Patent Publication 2002-344571, the present Assignee has disclosed a technique pertinent to a call apparatus and a call method according to which a user may have a call more pleasantly as he/she listens to the music. In such call apparatus, music contents data, used as BGM, are stored in storage means and, as a caller talks with a callee over call means, music contents are reproduced by reproducing means from the storage means. At this time, control means manages control to enable a party of call to hear both the voice from the counterpart party and the reproduced sound of the contents. The call means also transmits the reproduced sound of the contents to the counterpart party of call. Meanwhile, during call, the reproducing level of the music, used as the BGM, is lowered to a preset level, provided from the outset. This technique enables the user to enjoy the music as BGM, as he/she is having a call.

The present Assignee has also disclosed, in the Japanese Laid-Open Patent Publication H7-143221, a technique pertinent to a telephone apparatus in which plural music contents used as holding tone are captured from outside over the telephone network, recorded on a magneto-optical disc in association with identification data, and reproduced as the holding tone responsive to e.g. the selection by the user which is based on identification data.
[Patent Publication 1] Japanese Laid-Open Patent Publication 2001-118332
[Patent Publication 2] Japanese Laid-Open Patent Publication 2002-344571
[Patent Publication 3] Japanese Laid-Open Patent Publication H7-143221

However, in the technique disclosed in the Patent Publication 1, it has not been presupposed to use e.g. the BGM, used in the above Patent Publications 2 or 3, as contents. In a majority of cases, the contents, used as BGM, are music data. If the music data is used as the BGM during talk over the telephone or as a holding tone, not only the user who has copied the contents, but also the counterpart party of call hears the music. If the act of the counterpart party of call copying the music from the calling party, when the counterpart party of call has become fond of the music circulated as BGM, is performed without regulations, the copyright owner suffers from sizeable damages.

In short, copyright or the right of use may be set on sound source data files, used as BGM, such that it is necessary to prohibit the sound source data file, acquired by the user, from being copied or re-distributed without lowering its serviceability.

### SUMMARY OF THE INVENTION

It is therefore an object of the present invention to provide a call apparatus, a method for protecting the copyright of the BGM or SE file, and a call system, whereby the aforementioned problems of the prior art may be resolved.

For accomplishing the above object, a call apparatus for bidirectional communication for dialog by voice over a network, according to the present invention, includes downloading means for downloading a sound source data file for the music, as the sound sustained for several minutes as a time unit, or a sound source data file for the effect sound, sustained for several seconds as a time unit, from a server connected to the network, storage means for storage of the sound source data file, downloaded by the downloading means, hash value calculating means for calculating a hash value in a predetermined folder in the storage means, and setting means for setting the hash value, calculated by the hash value calculating means, as the system information. The copyright of the sound source data file is protected based on the hash value as set by the setting means.

When the sound source data file, downloaded by the downloading means, is stored in a predetermined folder in the storage means, the hash value in the predetermined folder is calculated by hash value calculating means. The hash value, calculated by the hash value calculating means, is set by the setting means as the system information. The copyright of the sound source data file is protected on the basis of the hash value set by the setting means.

Preferably, the call apparatus further comprises transmitting-time hash value calculating means for calculating the hash value in a predetermined area in the storage means, at a timing of starting the speech transmission, comparison means for comparing the transmitting-time hash value, as calculated by the transmitting-time hash value calculating means, to the hash value, set by the hash value setting means, as the system information, and user interface means for displaying the sound source data file stored in the storage means in case the comparison in the comparison means indicates that the hash value as calculated and the hash value as set are equal to each other.

The transmitting-time hash value calculating means calculates the hash value in the predetermined area in the storage means at a timing of starting the speech transmission. The comparison means compares the transmitting-time hash value, as calculated by the transmitting-time hash value calculating means, to the hash value, as set by the hash value setting means, as the system information. When the comparison in the comparison means indicates that the hash value as calculated and the hash value as set are equal to each other, the sound source data file stored in the storage means is displayed in the user interface means.

For accomplishing the above object, a copyright protection method according to the present invention comprises a downloading step of downloading a sound source data file for the music, as the sound sustained for several minutes as a time unit, or the effect sound, sustained for several seconds as a time unit, from a server connected to the network, a storage step for storing the sound source data file, downloaded by the downloading step, in storage means, a hash value calculating step of calculating a hash value in a predetermined folder in the storage means, and a setting step of setting the hash value, calculated by the hash value calculating step, as the system information. The copyright of the sound source data file is protected based on the hash value as set by the setting step.

Preferably, the copyright protection method further comprises a transmitting-time hash value calculating step of calculating the hash value in the predetermined area in the storage step at a timing of starting the speech transmission, a comparison step of comparing the transmitting-time hash value, as calculated by the transmitting-time hash value calculating step, to the hash value, as set by the hash value setting step, as the system information, and a user interface step of displaying the sound source data file stored in the storage step in case the comparison in the comparison step indicates that the hash value as calculated and the hash value as set are equal to each other.

For accomplishing the above object, a call system according to the present invention comprises a data file server for storage of a sound source data file for the music, as the sound sustained for several minutes as a time unit, or a sound source data file for the effect sound, sustained for several seconds as a time unit, and for supplying the sound source data file, responsive to a request from a client, and a control server for controlling bidirectional communication by the client. The client is supplied with a desired sound source data file from the data file server and has bidirectional communication with voice for dialog over a network. The data file server stores, in storage means, the user information of a client in terms of a sound source data file, requested by the client, as a unit. The control server sends the authentication information, sent by the client, to the data file server. The data file server retrieves the user information, stored in the storage means, based on the authentication information from the control server, to transmit a list of available sound source data files through the control server to the client, and the client retrieves a prescribed area in the storage device, to which the sound source data files are sent, based on the list of the available sound source data files received, to display only coincident sound source data files on a visual interface.

For accomplishing the above object, a copyright protection method according to the present invention is carried out in a call system including a data file server for storing a sound source data file for the music, as the sound sustained for several minutes as a time unit, or the effect sound, sustained for several seconds as a time unit, and for supplying the sound source data file, responsive to a request from a client, the client supplied with a desired sound source data file from the data file server and having bidirectional communication with voice for dialog over a network, and a control server for controlling bidirectional communication by the client. The method comprises a step of the data file server storing, in storage means, the user information of a client in terms of a sound source data file, requested by the client, as a unit, the control server sending the authentication information, sent by the client, to the data file server, a step of the data file server retrieving the user information, stored in the storage means, based on the authentication information from the control server, to transmit a list of the available sound source data files through the control server to the client, and a step of the client retrieving a prescribed area in the storage device where the sound source data files are stored, based on the list of the sound source data files received, to display only coincident sound source data files on a visual interface.

In the call apparatus according to the present invention, when the sound source data file, downloaded by the downloading means, is stored in a predetermined folder in the storage means, the hash value in the predetermined folder is calculated by hash value calculating means. The hash value, calculated by the hash value calculating means, is set by the setting means as the system information. The copyright of the sound source data file is protected on the basis of the hash value as set by the setting means. Thus, copying or re-distribution of the sound source data file, for which the copyright or the use right, for use as the BGM, is prescribed, may be suppressed without detracting from serviceability of the data file.

In the copyright protection method according to the present invention, the file downloaded by the downloading step is stored in storage means, the hash value in the predetermined folder of the storage means is calculated, the hash value calculated is set as the system information and the copyright of the sound source data file is protected on the basis of the as set hash value. Thus, copying or re-distribution of the sound source data file, for which the copyright or the use right, for use as the BGM, is prescribed, may be suppressed without detracting from serviceability of the file.

In the call system according to the present invention, the data file server stores, in storage means, the user information of a client in terms of a sound source data file, requested by the client, as a unit, and the control server sends the authentication information, sent by the client, to the data file server. The control server sends the authentication information, sent by the client, to the data file server, while the data file server retrieves the user information, stored in the storage means, based on the authentication information from the control server, to transmit a list of available sound source data files through the control server to the client. The client retrieves a prescribed area in the storage device, to which the sound source data files are sent, based on the list of the available sound source data files received, to display only coincident sound source data files on a visual interface. Thus, copying or re-distribution of the sound source data file, for which the copyright or the use right, for use as the BGM, is prescribed, may be suppressed without detracting from serviceability of the file.

In the copyright protection method, according to the present invention, the data file server stores, in storage means, the user information of a client, in terms of a sound source data file, requested by the client, as a unit. The control server sends the authentication information, sent by the client, to the data file server. The data file server retrieves the user information, stored in the storage means, based on the authentication information from the control server, to transmit a list of the available sound source data files through the control server to the client. The client retrieves a prescribed area in the storage device where the sound source data files are stored, based on the list of the sound source data files received, to display only coincident sound source data files in a visual interface. Thus, copying or re-distribution of the sound source data file, for which the copyright or the use right, for use as the BGM, is prescribed, may be suppressed without detracting from serviceability of the file.

### BRIEF DESCRIPTION OF THE DRAWINGS

FIG. 1 schematically shows a VoIP call system.

FIG. 2 depicts a flowchart for illustrating the measures for protecting the copyright of the VoIP call system.

FIG. 3, continuing to FIG. 2, depicts a flowchart for illustrating the measures for protecting the copyright of the VoIP call system.

FIG. 4 schematically shows the downloading sequence of sound source data in the VoIP call system.

FIG. 5 is a sequence diagram for illustrating the measures for protecting the copyright prior to call in the VoIP call system.

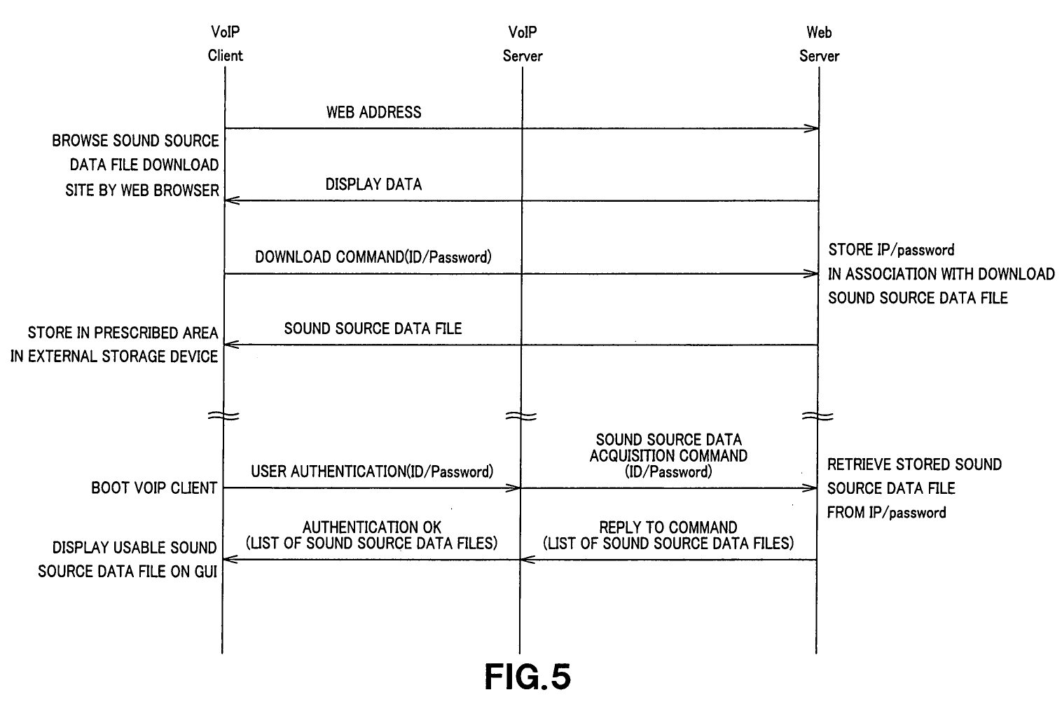

FIG. 6 schematically shows the call with the voice+BGM in the VoIP call system.

FIG. 7 is a sequence diagram for illustrating measures for copyright protection during call in the VoIP call system.

FIG. 8 is a functional block diagram of the VoIP client.

FIG. 9 is a format diagram of an RTP packet.

FIG. 10 shows a software module carried out by a VoIP client.

FIG. 11 schematically shows the hardware of a PC as a VoIP client.

FIG. 12 shows the GUI demonstrated on s display of a VoIP client.

FIG. 13 shows operations in a VoIP call system.

FIG. 14 shows a format diagram of a sound source data file stored in a database of a Web server.

FIG. 15 illustrates a sound source of the holding tone.

FIG. 16 shows a holding button on the GUI.

FIG.17 is a flowchart showing a processing sequence of a holding tone routine.

FIG. 18 is a flowchart showing another processing sequence of a holding tone routine.

FIG. 19 is a block diagram showing a high efficiency audio compression encoding unit.

FIG. 20 is a block diagram showing a high efficiency audio decompression decoding unit.

### DESCRIPTION OF THE PREFERRED EMBODIMENTS

As the best mode for carrying out the present invention, a Voice over IP (VOIP) call system, operating under the protocol of the Internet telephone, termed the VoIP, and a VoIP client, employed in this system, are hereinafter explained. The VoIP call system transmits/receives the background music (BGM) or the sound effect (SE), in addition to the call voice between the VoIP clients. The BGM may be exemplified by the background sound, made up by e.g. the sound of waves, chirpings of birds or music of genres of variable sorts, and which is sustained for several minutes as time unit. The SE may be exemplified by the effect sound, such as gunshots of machine guns, roll of thunder, hand clappings and laughing sound, sustained for several seconds as time unit.

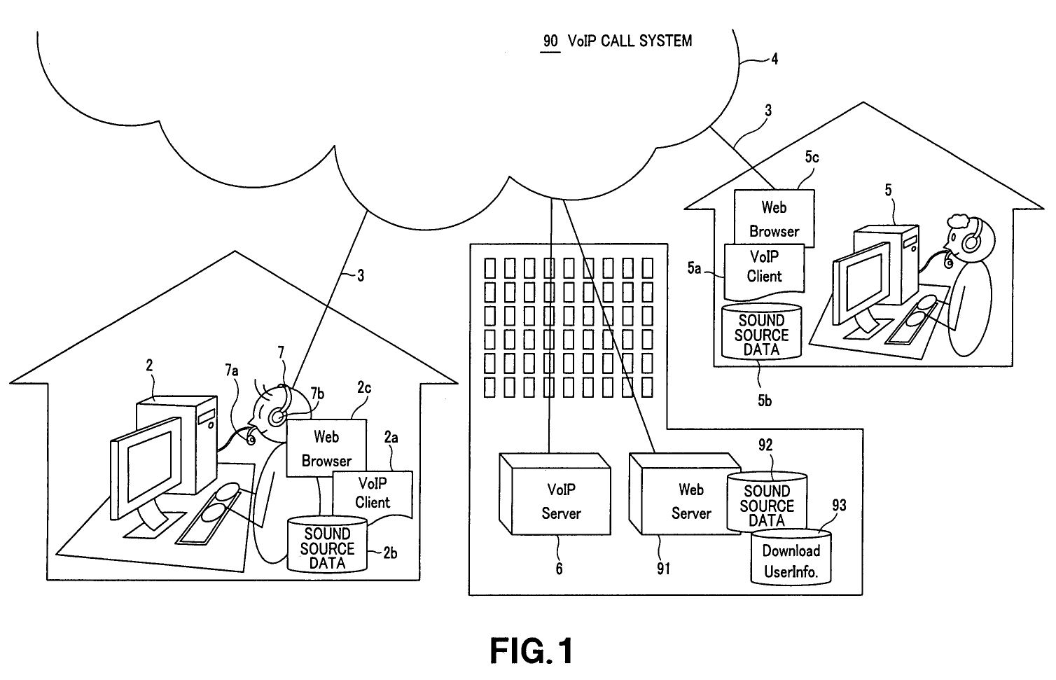

First, the schematics of the VoIP call system are explained. Referring to FIG. 1, a VoIP client 2 is connected over e.g. a public network 3 to the Internet 4, and has bidirectional communication with voice for dialog with another VoIP client 5 similarly connected to the Internet 4. To the Internet 4 is also connected a VoIP server 6, which manages control over communication based on VoIP. A VoIP server 91, cooperating with the VoIP server 6, is connected in the center or in the vicinity thereof, as is the VoIP server 6.

Meanwhile, in this VoIP call system 90, the call between two parties, namely the VoIP clients 2 and 5, is taken as an example. However, the number of the VoIP clients is, of course, not limited to two, such that there may be three or more parties taking part in the communication system.

The Internet 4 is a global network environment interconnecting a large number of communication networks, such as public networks, and information communication networks. Nowadays, broadband transmission is possible by coming into widespread use of the high speed and broadband communication networks. The network is formed with the communication network of 500 kbps or higher, using optical fibers, asymmetrical digital subscriber lines and wireless techniques.

The VoIP server 6 in the VoIP call system 1 supervises the IP addresses of contractors, while taking charge of authentication or managing control over communication. Of course, there may separately be provided a server for billing and a server for processing the management information, such as an IP address of the contractor.

The aforementioned SE file and the BGM file, for example, are stored, as sound source data, in a database 92. That is, the SE and the BGM are turned into e.g. PCM data, which are stored as file-based data pre-compressed by compression techniques, such as MP3, MPEG4 or ATRAC. Moreover, the user information on receipt of a sound source data download request from the VoIP client is stored as the download user information in a database 93.

The VoIP client 2 is e.g. a personal computer (PC) having connected thereto a headset 7 composed of a microphone and a loudspeaker or of a microphone 7a and a headphone 7b and which is worn by a user. The PC becomes the VoIP client 2 when the PC executes a VoIP client program 2a implemented by software. In the following, it is assumed that the VoIP client 2 calls up a VoIP client 5, that is, that the VoIP client 2 first transmits and the VoIP client 5 is a receiver. Of course, the VoIP client 5 is a PC executing a VoIP client program 5a and performs similar operations, in accordance with the present invention, when the VoIP client 5 first becomes a transmitting side.

The VoIP clients 2 and 5 have the function of accessing the Web server 71 by exploiting Web browsers 2c, 5c. The sound source data, such as these file or the BGM file, may be downloaded from the database 72, subject to payment of a fee to an undertaker supervising the Web server 91. The so downloaded sound source data files are stored in sound source data storage units 2b, 5b, formed in a HDD, such as a storage unit 58 as later explained. The sound source data storage units 2b, 5b are formed by an SE file storage unit 14 and a BGM file storage unit 15.

A VoIP call system 90, described above, uses the following measures, in order to prevent copying or redistribution of the sound source data files, the copyright or the use rights of which as the BGM are prescribed, without detracting from serviceability.

The schematics of the first measures are as follows: The VoIP client stores a sound source data file, downloaded from the Web server 91, in a preset folder. On completion of the downloading, the VoIP client calculates Hash values in the folder and causes the calculated value to be stored as the user-oriented system information. During VoIP call, the hash value in a folder is calculated and compared to the hash value stored as the system information. The sound source data file may be specified (displayed) only when the two hash values are equal to each other.

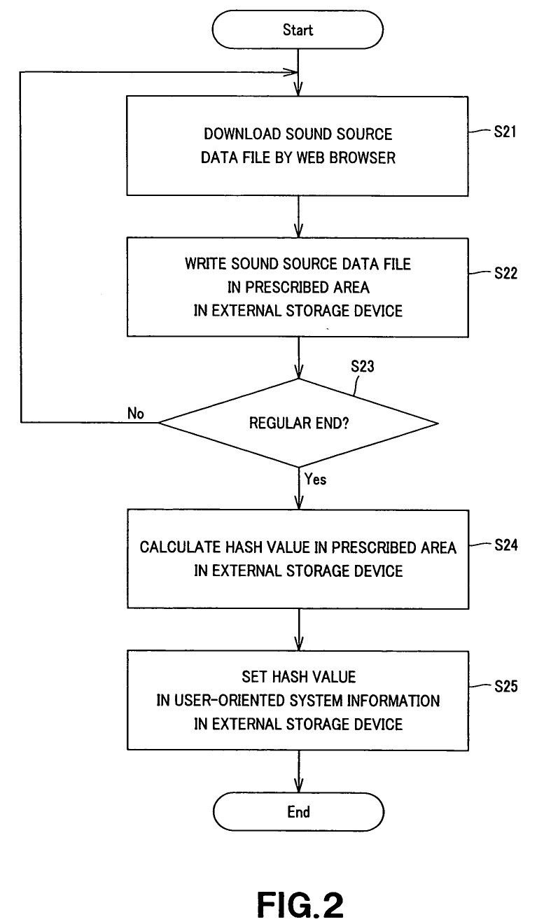

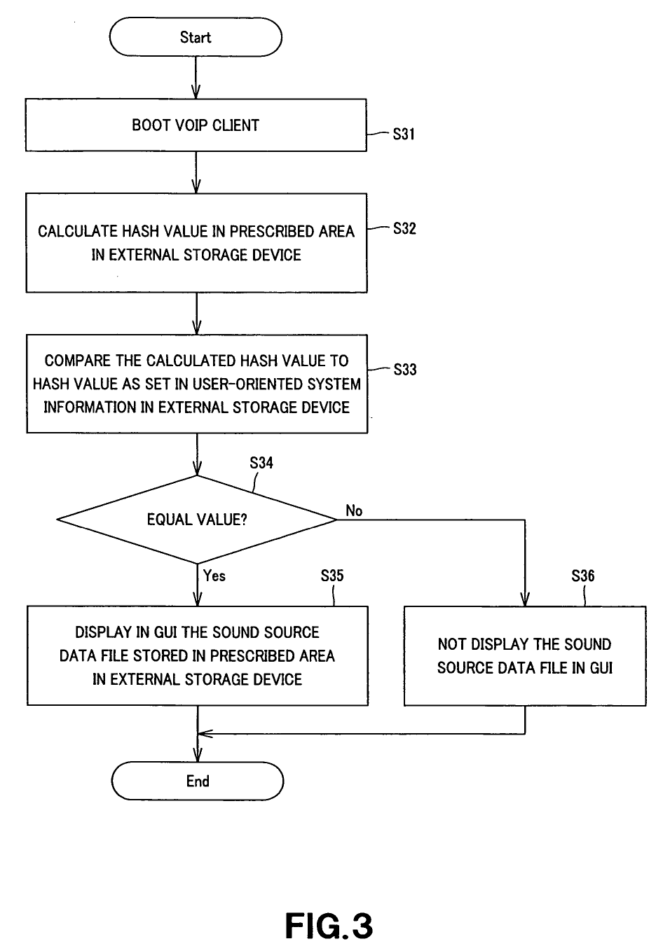

The processing sequence of the first measures is explained in detail with reference to FIGS. 2 and 3. The VoIP client 2 boots a Web browser 2c and accesses the Web server 91 to specify a desired sound source data file on the GUI for downloading to start the downloading (step S21 of FIG. 21). At this time, the downloaded sound source data file is written in a prescribed folder in the HDD forming an external storage device which will be explained subsequently (step S22). If it is determined in a step S23 that the writing has been completed regularly, processing transfers to a step S24. In this step S24, the hash value in the folder is calculated when the downloading is completed. This calculated hash value is set in the user-oriented system information in the external storage device (step S25).

For VoIP call, the VoIP client is booted (step S31). At this time, the hash value in the prescribed external storage device is calculated (step S32). The hash value calculated in the step S32 is compared to the hash value stored as the system information (step S33). If, as a result of comparison, the two hash values are verified to be equal (YES in a step S34), the sound source data file, stored in the prescribed area in the external storage device, is displayed on the GUI which will be explained subsequently (step S35). If, as a result of comparison, the two hash values are verified to be unequal (NO in the step S34), the sound source data file, stored in the prescribed area in the external storage device, is not displayed on the GUI.

With the above-described first measures, when a file different from a regularly downloaded sound source data file, for example, a file which a user had copied by his/her friend, is stored in the folder, the hash values become different from each other. Consequently, the file cannot be reproduced, thus protecting the copyright.

The schematics of the second measures are as follows: The user information (ID/password) which has downloaded the sound source data file is stored in an external storage device, on the sound source data file basis, by the Web server. If, during VoIP call, the Web server has received the user information (ID/password) from the VoIP server, the Web server retrieves the user information, stored in the external storage device, to notify the VoIP server of a list of the usable sound source data files. The VoIP server transmits the information on the list of the usable sound source data files, acquired from the Web server, as a response message of the user authentication, to the VoIP client. The VoIP client retrieves the prescribed area within the external storage device, in which to store the sound source data file, based on the received list of the sound source data. Only the coincident sound source data files may be specified (displayed) on the GUI.

With the second measures A, the sequence in the processing before VoIP call differs from that during VoIP call. For the following explanation, the processing before VoIP call and that during the VoIP call are labeled a processing sequence A of the second measures and a processing sequence B of the second measures, respectively.

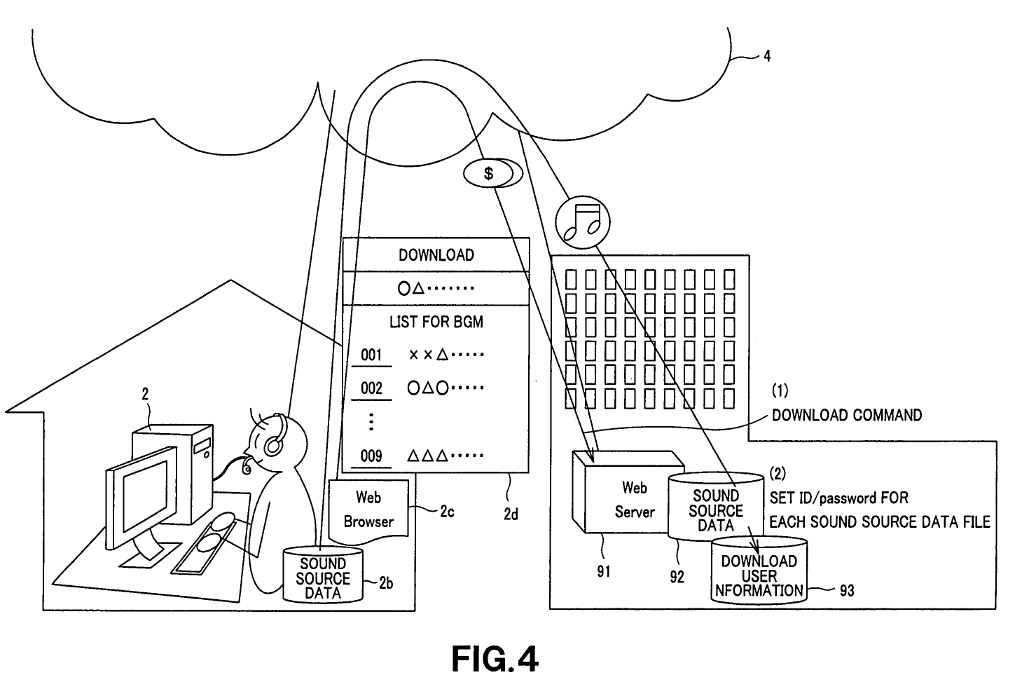

If, in the processing sequence A of the second measures, a user of the VoIP client 2 boots a Web browser 2c, and enters the Web address as URL, display data is sent from the Web server 91. The VoIP client 2 causes display data to be demonstrated from the Web server 91 on a display composed of an LCD or a CRT. For example, a download image surface 2d of FIG. 4 is displayed. When the user selects a desired sound source data file for BGM from the download image surface 2d, and issues a download command, the user information (ID/password) of the user is transmitted to the Web server 91. The Web server 91 causes storage of the user information (ID/password), which has downloaded the sound source data file, in an external storage device 93. The sound source data file, desired by the user, is sent from the database 92 to the VoIP client 2. The VoIP client 2 memorizes the desired sound source data file in a prescribed area in the external storage device.

When the user boots the VoIP client 2, in order to initiate the VoIP call, the VoIP client 2 sends the user information (ID/password) from the VoIP server 6 for user authentication. The VoIP server 6 transmits the user information, acquired by the user authentication of VoIP, to the Web server to issue a command for acquisition of sound source data. On receipt of the user information (IP/password) from the VoIP server 6 during VoIP call, the Web server 91 retrieves the user information, stored in the external storage device 93, to notify the VoIP server 6 of the list of available sound source data files.

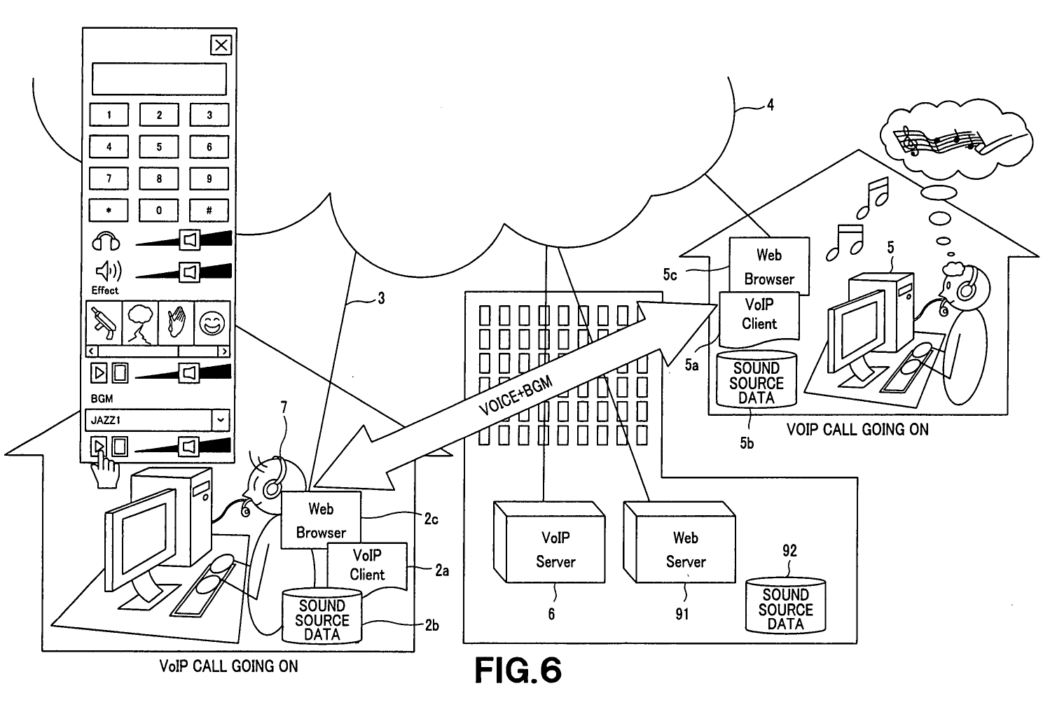

The VoIP server 6 transmits the information of the list of available sound source data files, acquired from the Web server 91, to the VoIP client 2, as a reply message of the user authentication. The VoIP client 2 retrieves the prescribed area in the external storage device, in which are stored the sound source data files, based on the received list of the sound source data files, to render only the coincident sound source data files displayable. The VoIP call, shown in FIG. 6, is then carried out, using the sound source data files for BGM or SE, as specified by the user on the GUI.

Thus, with the processing sequence A of the second measures, if a sound source data file, as acquired not from the Web server, but illicitly, is entered into a folder, such file is not displayed on the GUI, so that no sound source data file other than the regularly downloaded sound source data files can be used.

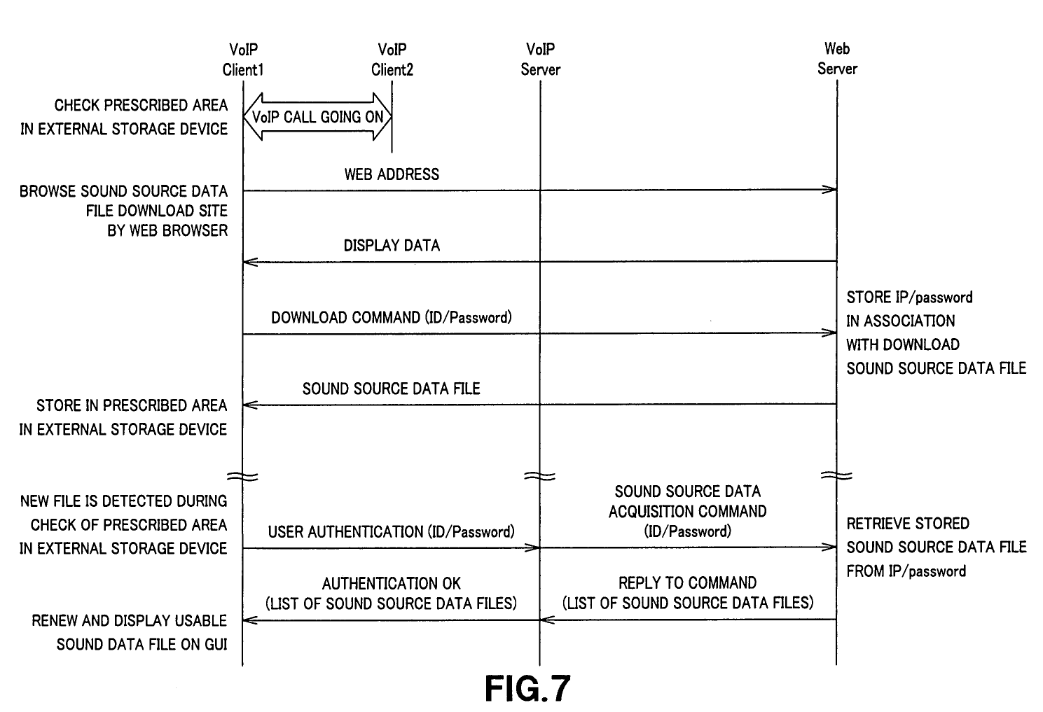

The processing sequence B of the second measures is now explained with reference to FIG. 7. This is the processing sequence for such a case where the VoIP client program 2a has already been booted between the VoIP client 2 and the VoIP client 5 and the VoIP call is going on. During the call, the VoIP client 2 boots the Web browser 2c by a multi-window.

When the user of the VoIP client 2 enters the Web address from the Web browser 2c as URL, display data are sent from the Web server 91. The display data from the Web server 91 are demonstrated on a display formed by the LCD or the CRT. For example, the download image surface 2d of FIG. 4 is displayed. When the user selects the desired sound source data file for BGM from the download image surface 2d, and issues a download command, the user's user information (ID/password) is transmitted to the Web server 91. The Web server 91 causes the user information (ID/password), which has downloaded the sound source data file, to be stored within the external storage device 93, in terms of the sound source data file as a unit. The sound source data file, desired by the user, is then sent from the database 92 to the VoIP client 2. The VoIP client 2 causes the desired sound source data file to be stored in the prescribed area in the external storage device.

When the VoIP client 2 is aware of the fact of storage in the prescribed area in the external storage device of the sound source data file, downloaded from the Web server 91, by detection of the file during the check of the prescribed area, the VoIP client 2 automatically executes the processing of authenticating the VoIP to send the user information (ID/password) for user authentication to the VoIP server 6. The VoIP server 6 transmits the user information, acquired by user authentication of VoIP, to the Web server, to issue a command for acquiring the sound source data. The Web server 91 retrieves the user information, corresponding to the user information (ID/password), sent thereto via VoIP server 6, from the external storage device 93, while retrieving the sound source data file, associated with the user information, from the database 92, to notify the VoIP server 6 of the list of the available sound source data files.

The VoIP server 6 sends the information of the list of the sound source data files, acquired from the Web server 91, to the VoIP client 2, as a reply message to the user authentication. The VoIP client 2 retrieves the prescribed area in the external storage device, in which are stored the sound source data files, based on the so received list of the sound source data files, to render only the coincident sound source data files displayable on the GUI.

Thus, if the sound source data file, as acquired not from the Web server, but illicitly, is entered into a folder, such file is not displayed on the GUI, so that no sound source data file other than the regularly downloaded sound source data files can be used, thus protecting the copyright or the use rights.

Meanwhile, the sound source data files, such as the SE files or the BGM files, stored from the Web server in the storage unit 58 by a preset processing sequence, may be compressed in a data format by the codec method, not used in the music reproducing function by e.g. a medium player owned by the PC, by a codec method not used in the music reproducing function, such as to render it difficult to reproduce the data file by the music reproducing function. After all, the aforementioned sound source data file is used for application as BGM or SE in the VoIP call system to assure copyright protection.

In the VoIP system 90, since the Web server 91 is connected on the Internet 4, as described above, the VoIP client 2 is able to designate usable sound source data to mix it with the input voice data file, not only before the VoIP call but also during the call. The sound source data file and the input voice data, thus mixed together, are encoded by the prescribed CODEC, packetized and periodically sent to the VoIP client of the counterpart party of call.

The VoIP client, as a transmitting side, is able to mix the music, sustained for e.g. several minutes as a unit as the background music (BGM), or the effect sound, sustained for e.g. several seconds as a unit, as the sound effect (SE), to the call voice. The VoIP client 2 individually adjusts the sound level of not only the call sound but also that of the background sound or the effect sound.

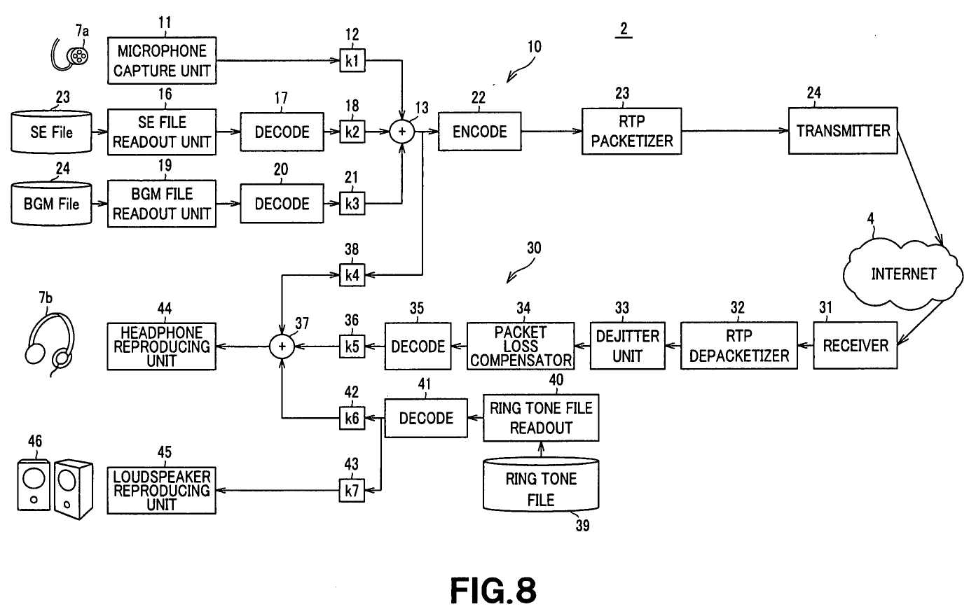

Referring to FIG. 8, the structure and the operation of the VoIP client 2, individually adjusting the sound levels of the background sound and the effect sound, are hereinafter explained. In the VoIP client 2, the transmitting system and the receiving system are functionally constructed, as now explained, by executing the VoIP client program 2a. First, in the transmitting system 10, the electrical signals, as transduced from the user's voice, picked up by the microphone 7a, are taken into the microphone capture unit 11. The electrical signals, corresponding to the voice, as picked up by the microphone capture unit 11, are multiplied by the gain adjustment unit 12 with the gain coefficient k1, which is the microphone sound volume level as set by the user. The resulting multiplied output of the gain adjustment unit 12 is sent to the adder 13.

A plural number of SE files, as sound source data files, downloaded from the Web server 91, are stored in the storage unit 14 of the VoIP client 2. The storage unit 14 for the SE files may be enumerated by a hard disc drive (HDD), a ROM or a magneto-optical disc, as later explained.

Similarly, a plural number of BGM files, as sound source data files, downloaded from the Web server 91, are stored in the storage unit 15 of the VoIP client 2.

If the SE file, stored in the SE file storage unit 14, is selected by the user, the so selected SE file is decoded by the decoder 17 into PCM data, as the SE file is read out by the SE file readout unit 16 into a RAM, not shown. The decoded output of the decoder 17 (PCM data) is multiplied by the gain adjustment unit 18 with the gain coefficient k2 which is the SE sound volume level as set by the user. The multiplication output of the gain adjustment unit 18 is sent to the adder 13.

If the BGM file, stored in the BGM file storage unit 15, is selected by the user, the so selected BGM file is decoded by the decoder 20 into PCM data, as the SE file is read out by the BGM file readout unit 17 into the RAM, not shown. The decoded output of the decoder 20 (PCM data) is multiplied by the gain adjustment unit 21 with the gain coefficient k3 which is the BGM sound volume level as set by the user. The multiplication output of the gain adjustment unit 21 is sent to the adder 13. The adder 13 sums the multiplication outputs of the gain adjustment units 12, 18 and 21 to send the resulting sum output to an encoder 22.

The encoder 22 compresses the sum outputs of the adder 13 (PCM data) by compression techniques, such as MP3, MPEG4 or ATRAC to tens of kbps, such as 64 kbps. The compression techniques by MP3, MPEG4 or ATRAC, used by the encoder 22, are the high efficiency audio compression encoding/decoding techniques, applied to e.g. the PCM audio data adopted with the CD. Hence, the sound packetized, transmitted over the Internet and reproduced on the receiving side, may be processed into stereo 2-channel sound of high sound quality.

The compression data are supplied to an RTP packetizer 23 designed to packetize data in accordance with Realtime Transport Protocol (RTP). The RTP packetizer 23 forms the compressed data into an RTP packet and packetizes the packet data into UDP and IP. The packetizing according to RTP will be explained in detail subsequently. The packetized packet data are sent from a transmission processor 24 to the Internet.

In a receiving system 30, the packet data, transmitted from the other VoIP client 5 over the Internet, are received by a receiving processor 31. The packetized data, received by the receiving processor 31, is depacketized by an RTP depacketizer 32. A de-jitter unit 33 corrects the arrival time based on the time stamp and the sequential number of the RTP released from the IP and the UDP by the RTP depacketizer 32.

A packet loss compensator 34 compensates the packet loss, based on the time stamp and the sequential number of the RTP, to send the compensated data to a decoder 35. The decoder 35 decodes the compressed data, corrected for the arrival time and compensated for the packet loss, into PCM data, to send the resulting PCM data to a gain adjustment unit 36. The gain adjustment unit 36 multiplies the PCM data with a gain coefficient k5 which is the replay sound volume level as set by the user for the PCM data. The multiplication output of the gain adjustment unit 36 is sent to an adder 37. For co-owning the transmitted call with the callee, the transmitted call data is multiplied by a gain adjustment unit 38 with a gain coefficient k4 which is the feedback sound volume level as set by the user for the transmitted call data. The multiplication output of the gain adjustment unit 38 is also sent to the adder 37.

Moreover, in this VoIP client 2, the ring tone is turned into e.g. PCM data, which is then pre-compressed by compression techniques, such as MP3, MPEG4 or ATRAC. The resulting pre-compressed data are then formed into file-based ring tone data and plural such files are stored in a ring tone file storage unit 39.

The ring tone file from the ring tone file storage unit 39 is pre-selected by the user and read out to a RAM, not shown, by a ring tone readout unit 40, in accordance with the incoming timing, so as to be decoded by a decoder 41 into PCM data. A decoded output of the decoder 41 is supplied to a gain adjustment unit 42 and to a gain adjustment unit 43. The gain adjustment unit 42 multiplies the ring tone decoding output (PCM data) with a gain coefficient k6, as the headphone ring tone volume as set by the user, and sends the resulting signal to the adder 37. The adder 37 sums a mixing output of the call voice as the multiplication output of the gain adjustment unit 36 and the background sound (PCM data) and the PCM data of the own call sound, as a multiplication output of the gain adjustment unit 38, and sends the sum output to a headphone reproducing unit 44. The headphone reproducing unit 44 converts the sum output into an analog signal, which is then amplified and sent to the headphone 7b. This headphone 7b utters the mixing sound to the user's ear.

At a timing the user is called up by the other VoIP client 5, the adder 37 sends to the headphone reproducing unit 44 the data corresponding to a product of a decoded output (PCM data) of the ring tone file as read out by the ring tone readout unit 40 and the gain coefficient k6 which is the headphone ring tone sound level as set by the user. The headphone reproducing unit 44 converts the ring tone data, multiplied by the gain coefficient k6, into analog data, which analog data is then sent to the headphone 7b. Thus, the headphone 7b utters the ring tone of the headphone ring tone sound volume level, as set by the user, to the user's ear, at a timing the user is called up by the other VoIP client 5.

The gain adjustment unit 43 multiplies the PCM data of the ring tone, output from the decoder 41, with a gain coefficient k7, which is the loudspeaker incoming sound volume level as set by the user, to send the resulting output to a loudspeaker reproducing unit 45. This loudspeaker reproducing unit 45 converts the multiplication output into an analog signal and amplifies the analog signal to output the resulting amplified signal. A loudspeaker 46 utters the incoming sound of the loudspeaker incoming sound volume level as set by the user for the loudspeaker.

The RTP based packetizing and depacketizing are hereinafter explained. The RTP is the transport protocol for transmitting/receiving the call or moving pictures in real-time on the IP network, such as the Internet, and is recommended by RFC1889. The RTP resides on a transport layer and is generally used on the User Datagram Protocol (UDP) along with the Real-Time Control Protocol.

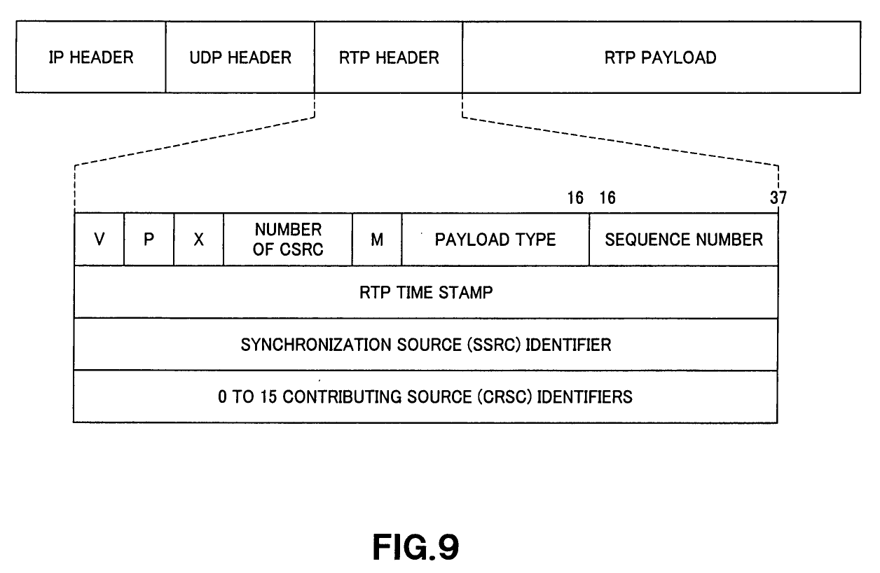

The RTP packet is composed of an IP header, a UDP header, an RTP header and RTP data, as shown in FIG. 9. In the RTP header, there are provided respective fields for storage of the version information (V), padding information (P), presence/absence of extension (X), number of contributing sources (CRSC), marker information (M), payload type (PT), a sequence number, an RTP time stamp, a synchronization source (SSRC) identifier, and a contributing source (CRSC) identifier.

The RTP packetizer 23, shown in FIG. 8, packetizes compressed data, output from the encoder 22, in accordance with the aforementioned RTP. The compressed data per se are contained in an RTP payload part shown in FIG. 9. This RTP packet is sent from the transmission processor 24 over the Internet 4 to other VoIP clients, such as the VoIP client 5 shown in FIG. 1.

In the receiving system 30 of the other VoIP client 5, the aforementioned RTP packet is received by the receiving processor 31. The operation of the other VoIP client 5 is now explained with reference to FIG. 8. The RTP depacketizer 32 separates the RTP header and the RTP data from the IP header and the UDP header. The sequence number and the time stamp, stored in the RTP header, are sent to a de-jitter unit 33.

The de-jitter unit 33 corrects inequalities in the arrival time based on the aforementioned sequence number and the time stamp. Since the RTP packet is transmitted over the Internet, along with other data, the RTP packet tends to be affected by congested transmission, such that the arrival time interval is not equal. That is, the arrival time interval may be stretched or congested on the time axis, thus possibly leading to unequal transmission time intervals. Thus, the de-jitter unit 33 corrects the arrival time intervals, based on the sequence number and the time stamp to provide for equal intervals.

The packet loss compensator 34 also compensates the packet loss, based on the aforementioned sequence number and time stamp. Since the RTP packet is transmitted/received over the Internet, the packets may be lost or become unable to be received. Thus, the packet loss compensator 34 uses a packet which is the same as that directly previous to or next following the missing packet, in place of the missing packet, or sets the missing packet to zero, to compensate for the packet loss.

The decoder 35 decodes the mixing data of the call voice and the background sound, corrected for arrival time and compensated for packet loss, to give PCM data.

In the VoIP client 2, having this functional structure, what becomes outstanding by the application of the present invention is that not only the sound volume level of the call sound but also that of the background sound may be adjustable individually.

The adjustment of the sound volume level of the call sound is carried out by multiplying the call data with the gain coefficient k1, as the microphone sound volume level, as set by the user, by the gain adjustment unit 12. On the other hand, the adjustment of the sound volume level of the background sound is carried out by multiplying the respective audio data with the gain coefficient k2, as the SE sound volume level, as set by the user, or the gain coefficient k3, as the BGM sound volume level, similarly as set by the user, by the gain adjustment unit 18 or by the gain adjustment unit 21.

The audio data of the call sound data, effect sound or the BGM, adjusted in the respective sound volume levels by the gain adjustment units 12, 18 and 21, are summed together by the adder 13 and encoded by the encoder 22. The resulting data is packetized by the RTP packetizer 23 and transmitted from the transmitter 24 to the other VoIP client 5 as the callee.

The other VoIP client 5 as the callee receives the RTP packet sent over the Internet 4 by the receiving unit 31, de-packetizes the packet by the RTP depacketizer 32, corrects the arrival time interval by the de-jitter unit 33, compensates for the packet loss by the packet loss compensator 34 and decodes the resulting data by the decoder 35 into PCM data. The as-decoded audio data (PCM data) is multiplied by the gain adjustment unit 36 with the gain coefficient k5, as the sound volume level. The receiving side user may hear the call sound from the caller, mixed with the BGM or with the SE, over the headphone reproducing unit 44.

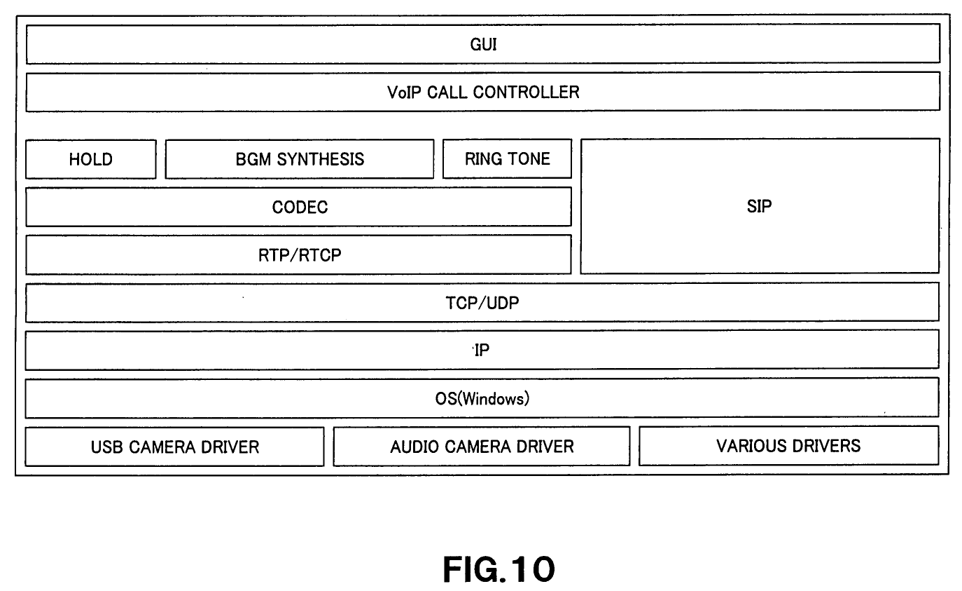

This VoIP client 2 achieves the function shown in FIG. 8 by executing the software module consistent with the protocol of each layer based on the architecture of the Open System Interconnection (OSI) shown in FIG. 10.

Referring to FIG. 10, each layer is explained, beginning from the lowermost layer and proceeding towards the uppermost layer. First, as the functions as the physical layer, there are a Universal Serial Bus (USB) camera driver, USB audio driver and various other drivers. This is a layer for matching to physical conditions of the transmission conditions of video data from the camera driver and audio data from the audio driver. As the function as a data link layer, there is an Operating System (OS), which is responsible for error-free data transmission between neighboring nodes.

As the function as the network layer, there is the Internet Protocol (IP). The network layer selects transmission routes used for data transmission/reception to manage communication control, such as flow control or quality control. The Internet Protocol (IP), as a connectionless packet transfer protocol not pursuing the operational reliability, trusts to upper layers (transport layer and application layer) as to the reliability guaranteeing function, flow controlling function and the error recovery function.

As the function as the transport layer, there is the Transport Control Protocol/User Datagram Protocol. The transport layer effectuates end-to-end transmission, using the IP address, while managing flow control or sequence control, in accordance with the quality class requested, without dependency upon the network sort. The TCP has the reliability guaranteeing function, accords a sequential number to each byte of the transmitted data, and re-sends data except if a receipt notice (acknowledgement) is sent from the receiver. The UDP provides the datagram sending function between the applications. In streaming reproduction of the call and the moving pictures, using the IP network, a transport protocol, re-transmitting data in case of error occurrence, such as TCP, can generally not be used. Moreover, TCP is the protocol for one-for-one communication and is unable to transmit the information to plural parties. Thus, for such purpose, the UDP is used.

The UDP is designed for an application process to transmit data to another application process on a remote machine with the least overhead. Thus, only the transmission source port number, destination port number, data length and the check sum are entered in the UDP header, while there lacks the header in which to enter the number representing the sequence of packets in the TCP. Thus, if the packet sequence interchange has occurred due to e.g. transmission of packets over different routes on the network, it is not possible to perform the processing of restoring the sequence to a correct state. On the other hand, both TCP and UDP lack in a field in which to enter the time information, such a time stamps, at the time of transmission.

As the function as the session layer, there are the Session Initiation Protocol (SIP) and a module which represents an essential part of the present invention, that is, a module required in the software responsible for synthesis of the call sound with the BGM or SE, namely the generation of holding tone, BGM synthesis, ring tone generation, codec and RTP. The session layer is responsible for information transmission control, and supervises the dialog mode between the applications to perform control of call units. The SIP is the signaling protocol for the application layer for establishing, changing and terminating the multi-media session on the IP network, and is standardized in RFC3261.

As the function as a presentation layer, there is the VoIP call control. The presentation layer supervises the form of expression of the information transmitted/received between the applications to convert or encrypt data.

As the function as the application layer, there is the Graphical User Interface (GUI). The application layer supervises the exterior specifications of the communication functions used in a user program to exchange the corresponding information.

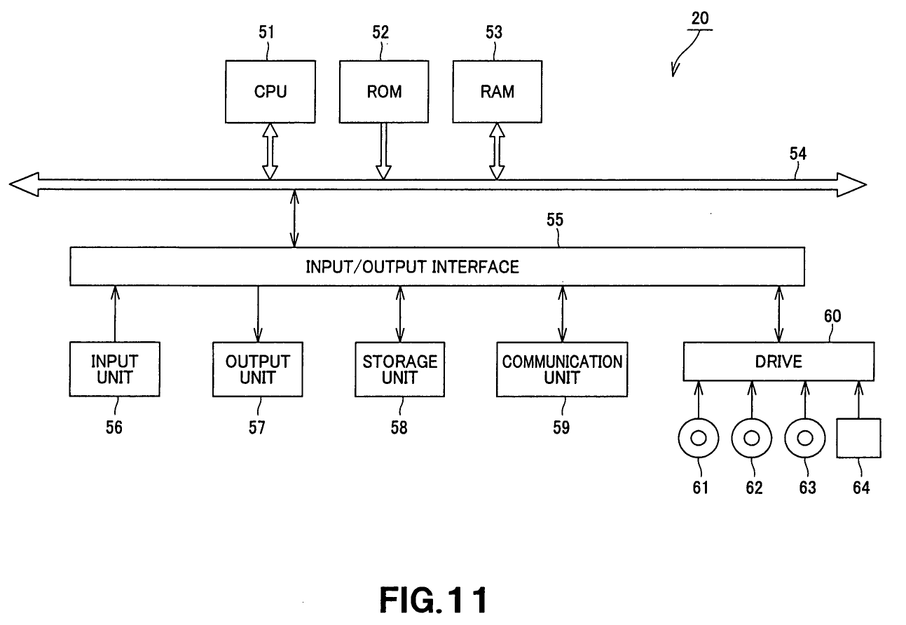

The hardware structure of the VoIP client 2, actually carrying out the aforementioned software module, is now explained. FIG. 11 shows the structure of the VoIP client 2 as the PC. Referring to FIG. 11, a CPU 51 executes various processing operations in accordance with various programs forming the aforementioned software module stored in a ROM (Read-Only Memory) 52 and also with various programs forming the aforementioned software module loaded from a storage unit 58 to a RAM (Random-Access Memory) 53. In this RAM 53, there are stored data needed for the CPU 51 to execute various processing operations.

The CPU 51, ROM 52 and the RAM 53 are interconnected over a bus 54. To this bus 54 is also connected an input/output interface 55. To this input/output interface 55 are connected an input unit 56, formed by a keyboard or a mouse, a display formed by a CRT or an LCD, an output unit 57, formed by a headphone or a loudspeaker, the aforementioned storage unit 58, formed by e.g. a hard disc, and a communication unit 59, formed by a modem or a terminal adapter. The microphone 7a is comprised in the input unit 56. The headphone 7b is comprised in the output unit 57.

The communication unit 59 carries out communication processing over the Internet 4, while outputting data received from the callee to the CPU 51, RAM 53 and to the storage unit 58. This storage unit 58 reciprocates data with the VPU 51 to save or erase the information. The communication unit 59 also executes communication processing of analog or digital signals with other clients.

To the input/output interface 55, there is connected a drive 60, as necessary. There are also mounted a magnetic disc 61, an optical disc 62, a magneto-optical disc 63 and a semiconductor memory 64, and the computer program read therefrom is installed as necessary in the storage unit 58.

Meanwhile, the storage unit 58 is e.g. a HDD, and forms the SE file storage unit 14, BGM file storage unit 15 and the ring tone file storage unit 39 shown in FIG. 8.

The above-described hardware structure represents a structure of the VoIP client 2 or 5, while also representing the structure of the VoIP server 6 or a Web server, as explained subsequently.

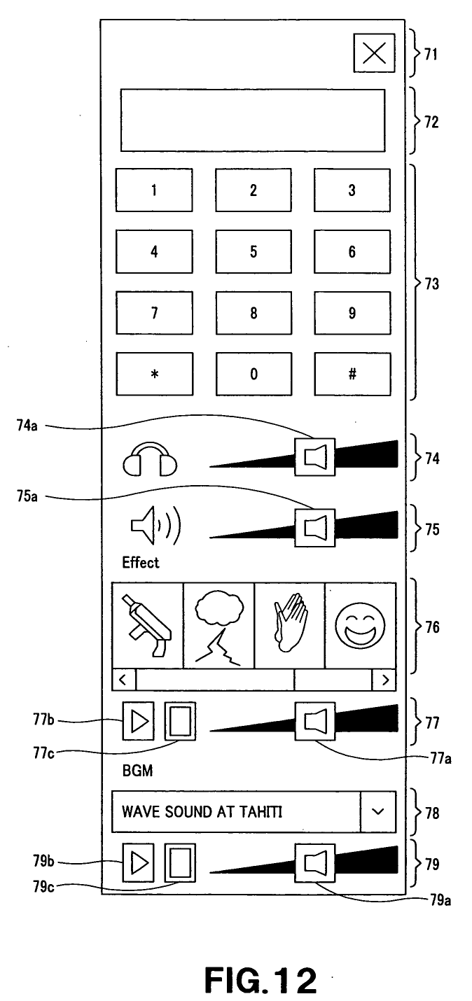

The GUI (Graphical User Interface), demonstrated on a display, forming the output unit 57, is explained with reference to FIG. 12. This GUI belongs to the application layer of the VoIP client. The GUI is an interface for the user to visually run the PC, and handles the information manually entered by the user. This GUI includes an application controller 71, an information display unit 72, a dial unit 73, a headset volume unit 74, a loudspeaker volume unit 75, an sound effect (SE) selection display unit 76, an SE controller 77, a BGM selection display unit 78 and a BGM controller 79, looking from above towards below in FIG. 12.

The application controller 71 performs termination processing for the VoIP client application. The information display unit 72 displays the dial number and the callee information (such as busy signal). The dial unit 73 is a ten-key used for dialing the VoIP callee. The headset volume unit 74 is used for adjusting the sound volume output from the headphone 7b of the headset 7. The gain coefficient k5 in the gain adjustment unit is set by the user causing left-and-right movement of the slider 74a using the mouse. The headset volume unit may also be used for adjusting the sound volume of the ring tone output from the headphone 7b. In this case, the gain coefficient k6 in the gain adjustment unit 42 is set by the user causing left-and-right movement of the slider 74a using the mouse.

The loudspeaker volume unit 75 is used for adjusting the volume of the ring tome output from the loudspeaker 46. The gain coefficient k7 in the gain adjustment unit 43 is set by the user causing left-and-right movement of the slider 75a using the mouse.

The SE selection display unit 76 is used for displaying a usable SE sound source data file for user selection (SE file stored in the SE file storage unit 14), and demonstrates the effect sound, such as gunshots of a machine gun, rolls of thunder, hand clappings or cheer for selection by the user. The SE controller 77 allows the user to reproduce and stop the effect sound and the sound volume adjustment via input init, such as a mouse, using a replay button 77b, a stop button 77c and a slider 77a.

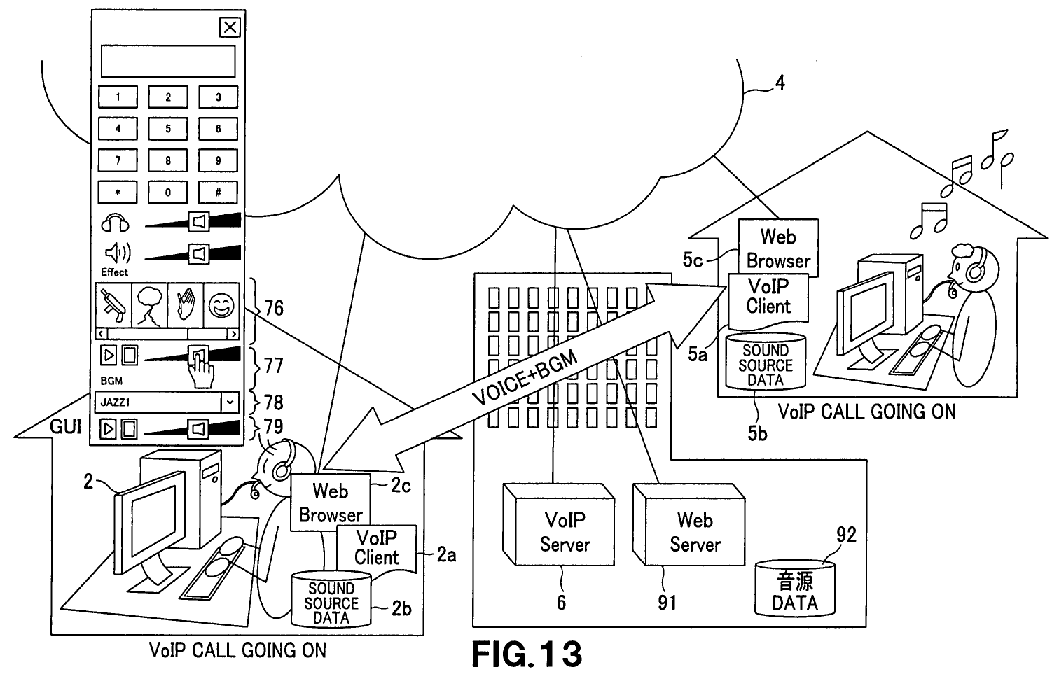

Assume that the user has selected a desired SE from the SE selection display unit 76, using a mouse, has caused the slider 77a to be moved to a proper position and has clicked the replay button 77b, as shown in FIG. 13. The decoder 17 then decodes the desired SE file, as read out by the SE file readout unit 16, to PCM data. The PVC data of the SE file is then multiplied by the gain adjustment unit 18 with the gain coefficient k2, which is the SE sound volume level for the slider 77a, and the resulting signal is then output to the adder 13. Thus, the user is able to express the feeling he/she entertains for the callee, by the various effect sounds.

The BGM selection display unit 78 displays available BGM sound source data files for selection by the user. The BGM controller 79 allows a user to reproduce or stop the BGM and to adjust the sound volume with the aid of a reproducing button 79b, a stop button 79c and a slider 79a. It is assumed that, in FIG. 13, the user of the VoIP client 2 has selected the desired BGM on the BGM selection display unit 78, using the mouse, shifts the slider 79a to a proper position and has clicked the reproducing button 79b. The decoder 20 then decodes the desired BGM file, as read out by the BGM file readout unit 19 to yield PCM data of the BGM file. This PCM data is multiplied in the gain adjustment unit 21 with the gain coefficient k3, as the BGM sound volume level associated with the slider 79a, and the resulting signal is output to the adder 13. In this manner, the user's feeling or the ambient atmosphere may be transmitted to the counterpart party of call with the sound volume as selected and adjusted by the user, as in the case of the SE.

Thus, by the VoIP client 2 executing the various programs forming the aforementioned software module, it is possible to solve the problem of the prior-art system that the speech sound entered over a microphone is hardly audible by the background sound set to a fixed sound volume level, or that, conversely, the effect as the background sound cannot be displayed. Moreover, since the transmitting and receiving sides use PCM data, which is compressed by the compression techniques, such as MP3, MPGE4 or ATRAC, transmission of audio data of high sound quality may be achieved, while the two-channel reproduction, for example, may be provided. Thus, by proper mixing of he call sound and the background sound, outstanding sound localization of the call sound from the transmitter may be achieved.

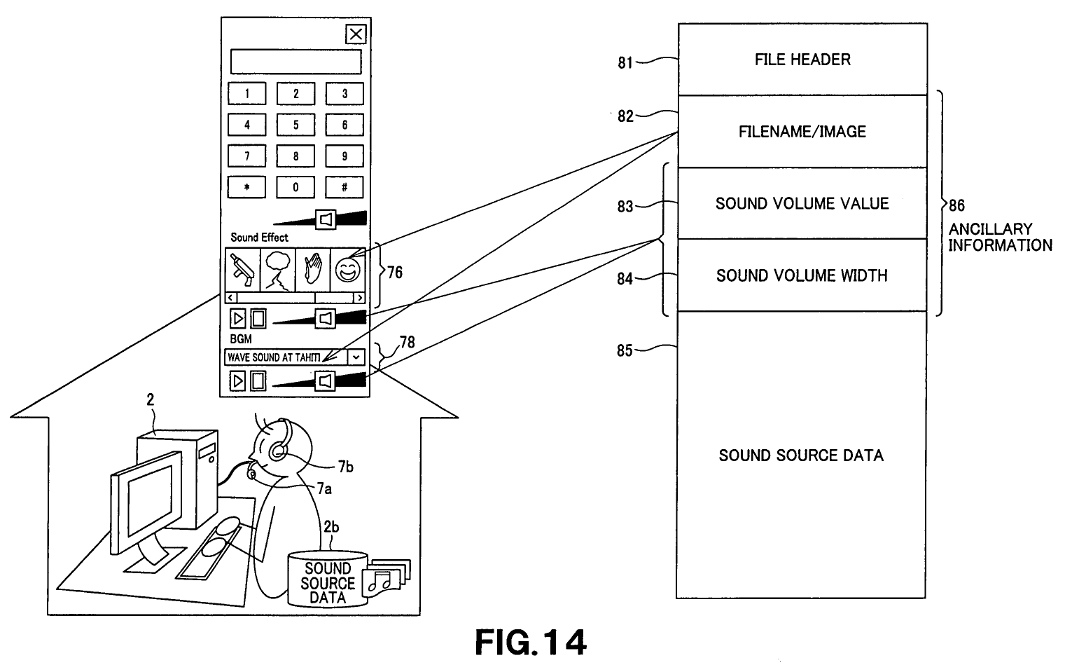

Each of the sound source data files, stored in the database 92 of the Web server 91, includes the information of a default sound volume 83 and the information of a sound volume width 84, as shown in FIG. 14. The file structure is now explained in more detail. In rear of a file header 81, there is a filename/image 82, demonstrated in the SE selection display unit 76 and in the BGM selection display unit 78. The filename/image is followed by a sound volume value 83, properly adjusted from file to file, and the sound volume width 84 between the maximum and minimum values, and then by sound volume data 85. The filename/image 82, sound volume value 83 and the sound volume width 84 represent ancillary information 86 of the sound volume data 85.

Thus, in each of the sound source data files, stored in the database 92 of the Web server 91, there are individually provided the information on the sound volume value 83 and the information on the sound volume width 84, so that the proper sound volume may be set from sound source data to sound source data. Consequently, the background or effect sound may be reproduced promptly without the user undertaking sound volume adjustment at the outset.

Moreover, the VoIP clients 2 and 5 may use the BGM as the holding tone. The operation of the VoIP client 2 reproducing the BGM file of the BGM file storage unit 15 is hereinafter explained.

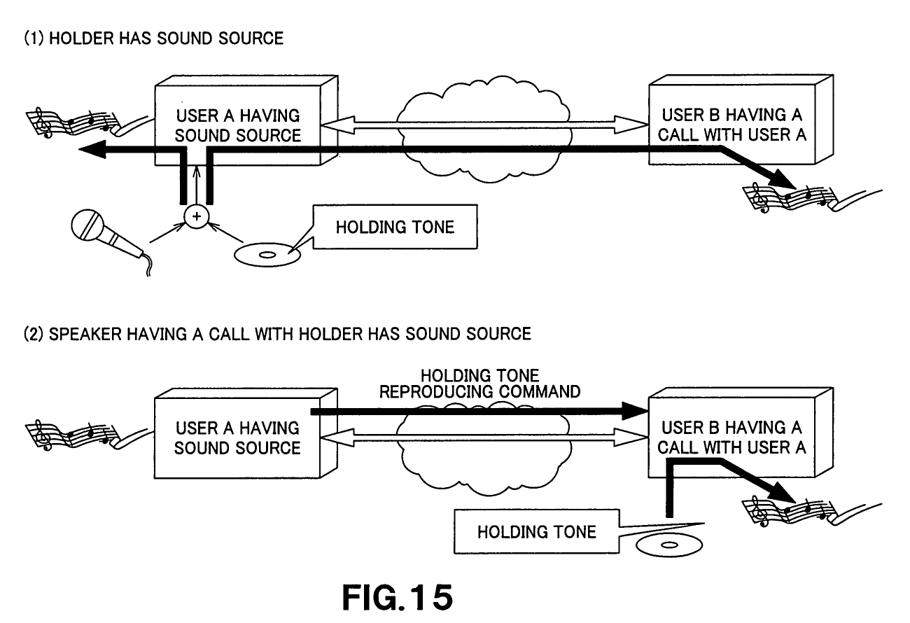

As for the holding tone, a holding party (user A) may have a sound source, as shown in FIG. 15 (1), or a party talking with the holding party (user A), that is, a user B having the talk with he user A, may have a sound source, as shown in FIG. 15 (2). In the case of FIG. 15 (1), in which the holding party has the sound source, transmission may be made in the same was as in the BGM reproducing system composed of the BGM file storage unit 15, BGM file readout unit 19, decoder 20 and the gain adjustment unit 21, shown in FIG. 15. Thus, the holding tone may be realized by a scheme which is the same as the scheme of the BGM reproducing system.

However, with BGM, it is a frequent occurrence that, due to its form of use, the sound volume is low and is not appropriate. Thus, in using the BGM as the holding tone, it may be contemplated to adjust the sound volume automatically.

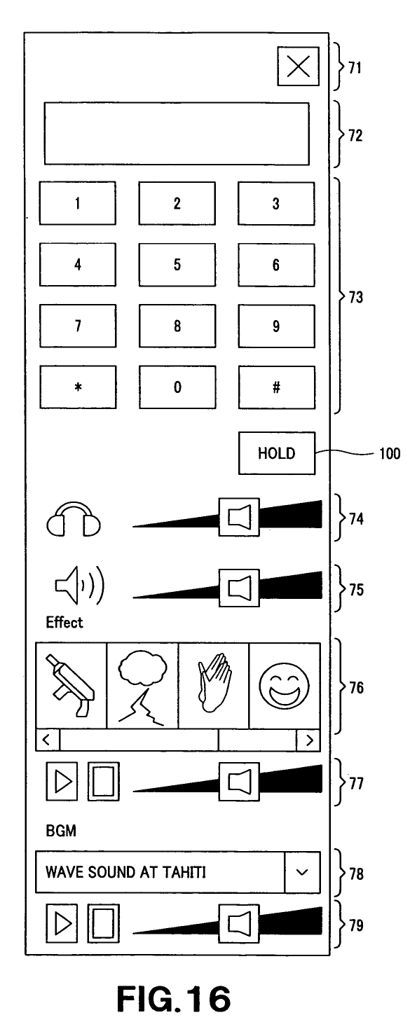

For example, if the VoIP client 2 is the caller and, as the user is speaking, the user's call is mixed with the BGM, and the user clicks a hold button 100 on the GUI of FIG. 16, the gain coefficient is automatically changed over to k3 in the gain adjustment unit 21 to give a larger sound volume in place of the sound volume set as BGM.

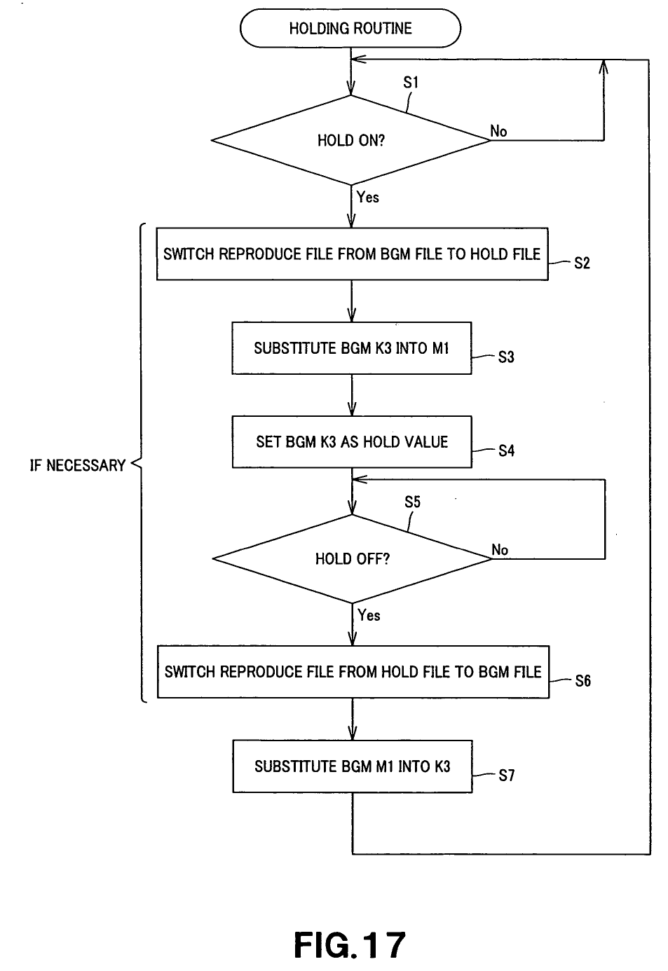

FIG. 17 shows an example of the holding tone routine. If it is verified in a step S1 that the hold button 100 of the GUI has been clicked and the hold ON state has been set (YES), the VoIP client 2 changes over the reproducing file from the BGM file to the hold file (step S2) and substitutes the BGM coefficient k3 for the call time into M1 (memory) (step S3). The BGM coefficient k3 is set to the level of the preset hold value (step S4). If then the hold button on the GUI is clicked and the hold OFF state has been confirmed (step S5), the reproducing file is switched from the hold file to the BGM file (step S6) and the value so far substituted into the M1 (memory) for BGM is substituted into k3 for use as BGM.

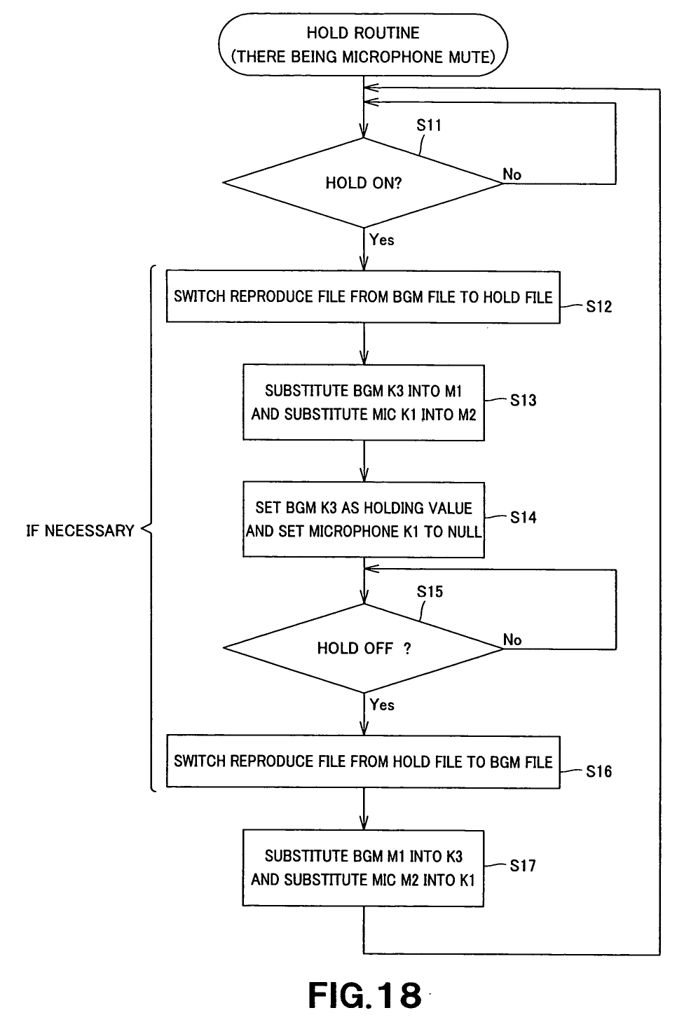

In changing over to the holding tone, the gain may simultaneously be set to zero for muting the sound volume of the microphone 7a. FIG. 18 shows an example of a holding routine in this case. If it is determined in a step S11 that the hold button 100 of GUI has been clicked and the hold ON state has been set (YES), the VoIP client 2 changes over the reproducing file from the BGM file to the hold file (step S12) and substitutes the BGM coefficient k3 for call time into M1 (memory), while substituting the value of the coefficient k1, multiplied by the output of the microphone 7a, into M2 (memory) (step S13). The BGM coefficient k3 is set to the level of the preset hold value, and the coefficient k1 for the microphone 7a is set to NULL (step S14). This raises the sound volume level of the BGM for holding tone, while the microphone 7a is turned off. If then the hold button is clicked on the GUI and the hold OFF state has been confirmed (step S15), the reproducing file is changed over from the holding file to the BGM file (step S16). The value substituted in M1 (memory) for BGM is substituted into the coefficient k3 for use as BGM, while the coefficient k1 for the microphone 7a is set to a value so far stored in the memory (M2) (step S17). If then the hold button is pressed, the BGM sound volume level is automatically adjusted to enable the BGM to be used as the holding tone and to enable the microphone 7a to be turned off. On the other hand, if the hold button is re-clicked to set the hold OFF state, the sound volume level again reverts to that for BGM, while the switch of the microphone 7a is turned ON.

Thus, if the BGM is used as the holding tone, the coefficient k3 of BGM is automatically set to a preset value so that the BGM may be used as the holding tone of an appropriate sound volume. Moreover, the use of BGM as the holding tone simplifies the structure of the VoIP client 2.

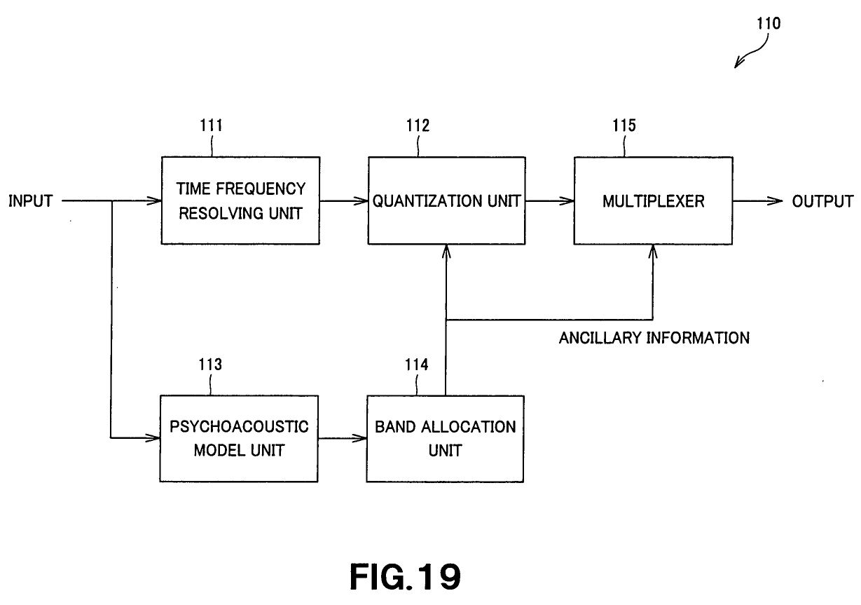

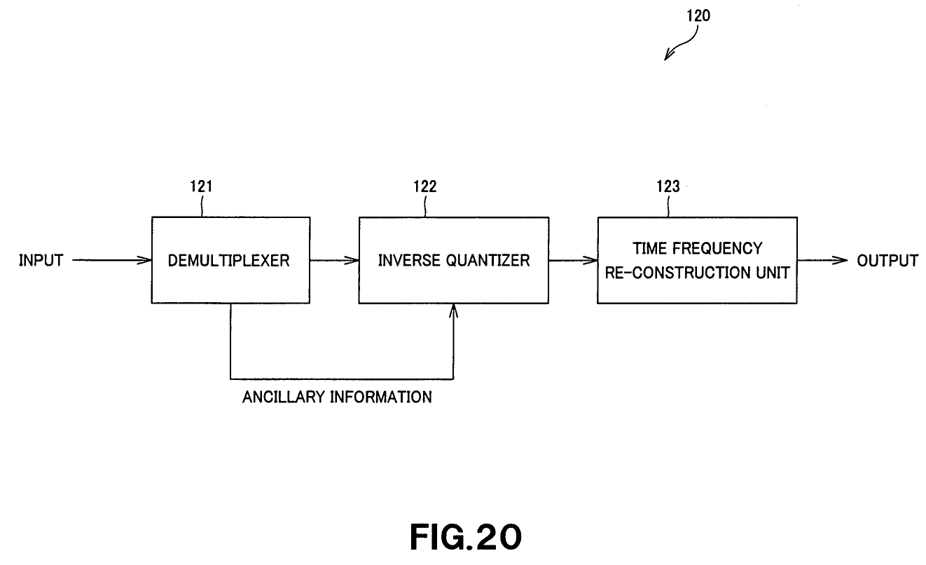

A specified embodiment of a high efficiency audio compression encoding and decompression decoding method, exploiting the psychoacoustic characteristics, is now explained. This can be applied to the data codec method used in an encoder and a decoder shown in Fig. Of course, the SE file and the BGM file, stored from the outset in the HDD, may be compressed and decompressed by this codec method. FIGS. 19 and 20 are block diagrams showing a high efficiency audio compression encoding unit and a high efficiency audio decompression decoding unit, respectively. The high efficiency audio compression encoding unit 110 corresponds to the encoder 22 shown in FIG. 8, and comprises a time frequency resolving unit 111, a quantization unit 112, a psychoacoustic model unit 113, a band allocation unit 114 and a multiplexer 115, as shown in FIG. 19.

The time frequency resolving unit 111 converts time-domain signals into blocks or frames, in terms of a preset time duration as a time unit, to transform the frame-based time-domain signals into signals on the frequency domain (by orthogonal transform) to split the signals into plural frequency bands.

The psychoacoustic model unit 113 splits the audio signals into plural (such as 25) bands, with bandwidths increasing with increase in the frequency (critical bands). The band allocation unit 114 allocates a preset number of bits or allocates adaptively changing numbers of bits from band to band (bit allocation). For example, if coefficient data obtained by modified discrete cosine transform (MDCT) are encoded by MDCT, adaptively variable numbers of bits are allocated to the band-based MDCT coefficient data obtained by the frame-based MDCT processing.

The quantization unit 112 determines the quantization step or the quantization size, based on the numbers of bits allocated from band to band, to carry out the quantization.

The multiplexer 115 multiplexes the quantized data, along with the subsidiary information, such as number of bits, allocated by a band allocation unit, and outputs the resultant data.

With this high efficiency encoding method, such bit allocation may be made in which the total bit rate of the entire audio information channels is variable and does mot exceed a preset maximum value.

Referring to FIG. 20, the high efficiency audio decompression decoding unit 120 includes a demultiplexer 121, an inverse quantizer 122 and a time frequency re-construction unit 123. The demultiplexer 121 is supplied with the high efficiency encoded data and demultiplexes the so supplied encoded data. The inverse quantizer 122 inverse-quantizes the quantized data, based on the subsidiary information, such as the band information, taken out from the demultiplexer 121, while the time frequency re-construction unit 123 transforms the time-domain data into frequency-domain data, to output the resulting frequency-domain data.

The above-described high efficiency audio compression encoding unit 110 provides for high quality call.

The above-described embodiment is arranged so that the PC as the VoIP client executes the VoIP client program. Alternatively, the VoIP client may be a mobile phone or PDA performing the function shown in FIG. 8. Still alternatively, the VoIP client may also be an apparatus implementing the functional unit of FIG. 2 as the hardware.

1. A call apparatus for bidirectional communication with voice for dialog over a network, comprising
downloading means for downloading a sound source data file for the music, as the sound sustained for several minutes as a time unit, or a sound source data file for the effect sound, sustained for several seconds as a time unit, from a server connected to the network;
storage means for storage of said sound source data file, downloaded by said downloading means;
hash value calculating means for calculating a hash value in a predetermined folder in said storage means; and
setting means for setting said hash value, calculated by said hash value calculating means, as the system information; wherein
the copyright of the sound source data file is protected based on said hash value as set by said setting means.

2. The call apparatus according to claim 1 further comprising
transmitting-time hash value calculating means for calculating the hash value in a predetermined area in said storage means at a timing of starting the speech transmission;
comparison means for comparing the transmitting-time hash value, as calculated by said transmitting-time hash value calculating means, to the hash value, set by said hash value setting means, as the system information; and
user interface means for displaying the sound source data file stored in said storage means in case the comparison in said comparison means indicates that said hash value as calculated and said hash value as set are equal to each other.

3. A copyright protection method in a call apparatus for bidirectional communication with voice for dialog over a network, said method comprising
a downloading step of downloading a sound source data file for the music, as the sound sustained for several minutes as a time unit, or the effect sound, sustained for several seconds as a time unit, from a server connected to said network;
a storage step for storing said sound source data file, downloaded by said downloading step, in storage means;
a hash value calculating step of calculating a hash value in a predetermined folder in said storage means; and
a setting step of setting said hash value, calculated by said hash value calculating step, as the system information; wherein
the copyright of the sound source data file is protected based on said hash value as set by said setting step.

4. The copyright protection method according to claim 3 further comprising
a transmitting-time hash value calculating step of calculating the hash value in the predetermined area in said storage step at a timing of starting the speech transmission;
a comparison step of comparing the transmitting-time hash value, as calculated by said transmitting-time hash value calculating step, to the hash value, set by said hash value setting step, as the system information; and
a user interface step of displaying the sound source data file stored in said storage step in case the comparison in said comparison step indicates that said hash value as calculated and said hash value as set are equal to each other.

5. A call system comprising
a data file server for storage of a sound source data file for the music, as the sound sustained for several minutes as a time unit, or a sound source data file for the effect sound, sustained for several seconds as a time unit, and for supplying the sound source data file, responsive to a request from a client;
said client supplied with a desired sound source data file from said data file server and having bidirectional communication with voice for dialog over a network; and
a control server for controlling bidirectional communication by said client; wherein
said data file server stores, in storage means, the user information of a client in terms of a sound source data file, requested by said client, as a unit;
said control server sends the authentication information, sent by said client, to said data file server;
said control server sends the authentication information, sent by said client, to said data file server;
said data file server retrieves the user information, stored in said storage means, based on said authentication information from said control server, to transmit a list of available sound source data files through said control server to said client; and wherein
said client retrieves a prescribed area in said storage device to which said sound source data files are sent, based on said list of the available sound source data files received, to display only coincident sound source data files in a visual interface.

6. The call system according to claim 5 wherein said control server sends said authentication information, supplied from said client during call, to said data file server.

7. The call system according to claim 5 wherein the information on the default sound volume information and the default sound width information are stated in a file of said music or said effect sound, stored in said data file server.

8. A copyright protection method carried out in a call system including a data file server for storage of a sound source data file for the music, as the sound sustained for several minutes as a time unit, or the effect sound, sustained for several seconds as a time unit, and for supplying the sound source data file, responsive to a request from a client;
said client supplied with a desired sound source data file from said data file server and having bidirectional communication with voice for dialog over a network; and
a control server for controlling bidirectional communication by said client; said method comprising the steps of
said data file server storing, in storage means, the user information of a client in terms of a sound source data file, requested by said client, as a unit;
said control server sending the authentication information, sent by said client, to said data file server;
said data file server retrieving the user information, stored in said storage means, based on said authentication information from said control server, to transmit a list of the available sound source data files through said control server to said client; and
said client retrieving a prescribed area in said storage device where said sound source data files are stored, based on said list of the sound source data files received, to display only coincident sound source data files in a visual interface.

9. The copyright protection method according to claim 8 wherein said control server sends said authentication information, supplied from said client during call, to said data file server.

10. The copyright protection method according to claim 8 wherein the information on the default sound volume information and the default sound width information are stated in a file of said music or said effect sound, stored in said data file server.
